(19) United States
(12) Patent Application Publication
(10) Pub. No.: US 2010/0095371 A1
(43) Pub. Date: Apr. 15, 2010

(54) Visual authentication systems and methods

(76) Inventor: Mark Rubin, Gaithersburg, MD (US)

Correspondence Address: TRIANGLE PATENTS, P.L.L.C., P.O. BOX 28539, RALEIGH, NC, 27611-8539, US

(21) Appl. No.: 12/287,770

(22) Filed: Oct. 14, 2008

(51) Int. Cl. H04L 9/32; G06F 7/04

(52) U.S. Cl. 726/18

(57) ABSTRACT

Methods for authenticating a user including presenting a series of images that are solely identifiable by the user, and that are not otherwise capable of being represented or expressed by the user, apart from the recognition thereof. Additionally, methods are provided that include the use of a gradient of morphed images created from a related set of initial images, including facial photos of various emotions that have been morphed into discernable images that are uniquely identifiable by a single user for use in authenticating the identification of that user by a secure system.

### BACKGROUND OF THE INVENTION

1. Field of the Invention

The present invention relates generally to authentication methods. Further, the present invention relates to visual pattern-based authentication for individuals.

2. Description of the Prior Art

Authentication for individuals is known to be provided by userid and password systems, biometric identification authentication, and recognition-based methods. Image recognition is also known in the art, including methods and systems wherein a user's claimed identity is verified or authenticated through the user of a computer system wherein the user selects a sequence of images from a displayed assemblage of images. These images consist of random patterns, fractals, and defined images of objects.

Examples of relevant prior art include the following:

U.S. Pat. No. 7,266,693 for Validated mutual authentication describes a method of authenticating a user including the steps of establishing a validating fractal image during an enrollment or other process; providing a plurality of fractal images to a client during an authentication attempt by a user, wherein the plurality of fractal images includes a validating fractal image; receiving the fractal image; and authenticating the user only if the fractal image selected by the user is that validating fractal image.

U.S. Pat. No. 7,219,368 for Robust visual passwords, which describes a method for authenticating a user including the steps of receiving an input pattern on a graphical interface, wherein the input pattern includes a sequence of discrete graphical choice; converting each discrete graphical choice into an input value to produce a sequence of input values; hashing the sequence to produce sequence of code words; and authenticating a user if the hash matches a stored hash.

U.S. Pat. No. 7,188,314 and US Patent Application Pub. No. 2004/0119746 for a System and method for user authentication interface.

U.S. Pat. No. 7,073,067 and US Patent Application Pub. No. 2004/0225899 for Authentication system and method based upon random partial pattern recognition.

U.S. Pat. No. 5,559,961 for a Graphical password describes a graphical password arrangement, wherein a user seeking access to a resource is presented with a predetermined image on a visual display, and the user is required to point and touch one or more predetermined positions on the displayed image in a predetermined order in order to be authenticated and allowed access to the resource.

US Patent Application Pub. No. 2004/0225880 for Strong authentication systems built on combinations of “what user knows” authentication factors.

US Patent Application Pub. No. 2004/0230843 for System and method for authenticating users using image selection, wherein the user creates a password based on the user selecting a sequence of images from displayed images, and also describes the manner in which the user selects the images; and based on the images selected, a password is generated by selecting a corresponding letter for each image.

US Patent Application Pub. No. 2004/0123151 for Operation modes for user authentication system based on random partial pattern recognition that describes a method for interactive authentication of a user, including steps of presenting a graphical user interface to the user that prompts the user to enter an authentication pattern having a random subset of data fields, wherein each of the data fields in the random subset have field contents including a set of storage units having more than one alpha-numeric characters, images, and colors; presenting a clue in the graphical user interface to the user indicating which of the data fields in the ordered set are included in the random subset; and accepting user input of alpha-numeric characters, images, and colors in the data entry fields, and wherein the authentication method includes a graphical object including status of login session.

US Patent Application Pub. No. 2003/0093699 for Graphical passwords for use in a data processing network describes a method of authorizing access to restricted information in a data processing network, including the steps of determining whether access to a specific document is restricted; providing at least one password document made up of a plurality of icons for selection by a user; and detecting whether the user's selection of one or more of the icons from the password documents grants authority to access the requested documents.

Notably, the prior art provides for authenticating, i.e., verifying the claimed identity of users of a computer system through the selection of a sequence of images from a displayed assembly of images, including random patterns, fractals, and defined images of objects. However, none of the prior art teach or disclose the use of a gradient of morphed images created from a related set of initial images, that are uniquely identifiable by a single user for use in authenticating the identity of that user for authorizing and/or providing access to a secure system. More particularly, none of the prior art teach or disclose the use of a gradient of morphed images created from a related set of initial images, including facial photos of various emotions that have been morphed into discernable images that are uniquely identifiable by a single user for use in authenticating the identification of that user by a secure system.

Thus, there remains a need for systems and methods that provide for completely secure user identity and related access/authorization wherein the user identifies a pattern from a series or sequence of images presented, and wherein the pattern is impossible for the user or anyone to describe, but possible to know and therefore to recognize.

### SUMMARY OF THE INVENTION

A first aspect of the present invention is to provide a series of images including a gradient of morphed images that are created from a related set of initial images. More particularly, the related set of initial images are preferably uniquely identifiable by a single user. By way of example and not limitation, the set of initial images includes facial expressions of the user, including facial photos showing expressions of emotion morphed into discernable images by that user and that user alone.

The various stages of emotion are created from four images for extreme conditions or emotions, and by morphing combinations of all four images. Importantly, these images are discernable by the user but are not describable or reducible to representation by finite language. Also, preferably, no other person can identify the pattern because it is specific to the user and relies on the combination of visual stimulation and memory of the feeling associated with the visual representation of the emotion represented by the image. Thus, they provide an authentication key that only the user can identify following visual presentation of them.

A second aspect of the present invention is to provide a method using a gradient of morphed images created from a related set of initial images that have been morphed into discernable images that are uniquely identifiable by a single user for use in authenticating the identification of that user by a secure system.

The present invention is further directed to a method for authenticating the identity of a unique user by providing a gradient of morphed images including an initial image and including representation of facial expressions of various emotions of that user, wherein the images can be identified but not expressed verbally by the user.

Thus, the present invention provides secure system access or authorization for a unique user whose identity is authenticated when the user correctly identifies a series of images including a first image and a gradient of morphed images created from a related set of initial images that are uniquely identifiable only by that user, and which cannot be represented verbally, but only recognized or identified by the user upon visual review of the same.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a series of images used in the methods of the present invention.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides a unique, personal authentication system and methods that is founded on the use of information that can be known, but not expressed in words. That information is provided in a visual form and is presented to the user for selection as part or all of the authentication (user identification and authorization); the visual form includes a series of images including a gradient of morphed images that are created from a related set of initial images that are known or recognizable by the user, but not expressed in words or articulated to a third party, without the actual selection being made by the user. More particularly, the related set of initial images are preferably uniquely identifiable by a single user. By way of example and not limitation, the set of initial images includes facial expressions of the user, including facial photos showing expressions of emotion morphed into discernable images by that user and that user alone.

As will be understood by one of ordinary skill in the art, the user authentication is used as a required step or component for access to a secure system, including by way of example and not limitation a computer, a computer network, a proximity access system, and the like and combinations thereof.

In one embodiment of the present invention, the authentication system and methods are based upon a series of images representing emotional states or expressions of emotional states of the user. A multiplicity of images associated with various stages of emotion are created from a smaller number of images for extreme conditions or emotions, preferably at least four images, and by morphing combinations of a subset of the smaller number of images, preferably two images of the four images. Importantly, these images are discernable by the user but are not describable or reducible to representation by finite language. Also, preferably, no other person can identify the pattern because it is specific to the user and relies on the combination of visual stimulation and memory of the feeling associated with the visual representation of the emotion represented by the image. Thus, they provide an authentication key that only the user can identify following visual presentation of them.

Thus, the present invention provides secure system authorization of use and/or access by providing methods for authenticating a user including presenting a series of images that are solely identifiable by the user, and that are not otherwise capable of being represented or expressed by the user, apart from the recognition thereof. Additionally, methods are provided that include the use of a gradient of morphed images created from a related set of initial images, including facial photos of various emotions that have been morphed into discernable images that are uniquely identifiable by a single user for use in authenticating the identification of that user by a secure system

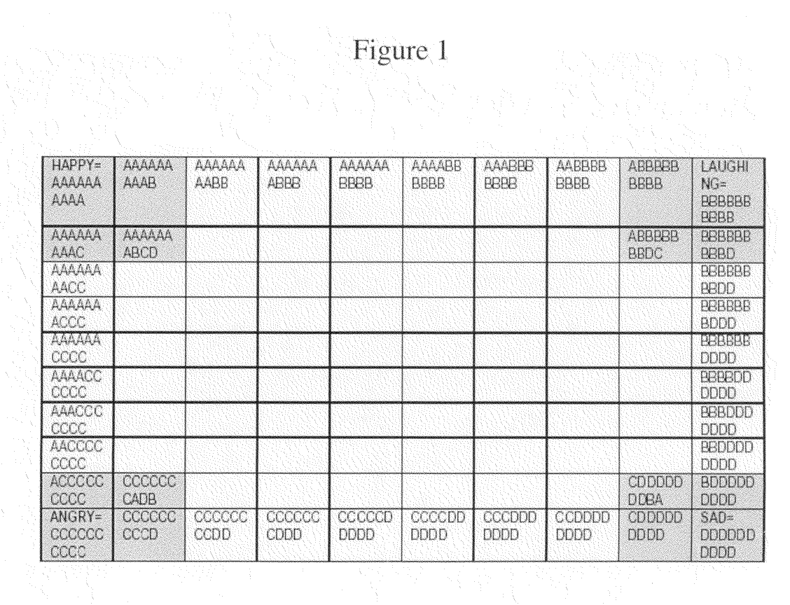

Referring now to the drawing(s) in general, the illustrations are for the purpose of describing a preferred embodiment of the invention and are not intended to limit the invention thereto. As best seen in FIG. 1, a series of images is shown, including a first image and at least one next image, preferably more than two images.

Notably, the prior art provides for authenticating, i.e., verifying the claimed identity of users of a computer system through the selection of a sequence of images from a displayed assembly of images, including random patterns, fractals, and defined images of objects. However, none of the prior art teach or disclose the use of a gradient of morphed images created from a related set of initial images, that are uniquely identifiable by a single user. More particularly, the prior art images do not include key factors of the present invention, including images that are identifiable and recognizable that are effectively usable as the first image and next image are images of a face, and in particular, the face is that of the user making an expression associated with an emotion that is memorable or can be remembered easily by the user, but not otherwise completely or accurately reproduced in any form by the user, including being described or expressed verbally. Additionally, none of the prior art teach or disclose the use of a gradient of morphed images created from a related set of initial images, including facial photos of various emotions that have been morphed into discernable images that are uniquely identifiable by a single user for use in authenticating the identification of that user by a secure system.

The present invention provides methods for authentication of an individual including the steps of: providing an automated system for controlling access by users, the system including a computer having memory, a processor, a power source, and a display having graphic user interface (GUI), wherein the system is operable for user interaction; presenting a series of discernable images on the GUI to an individual user; requiring the individual user to input at least one selection relating to the series of discernable images; authenticating the user and authorizing access if the user input matches previously stored initial settings that are preferably established by the same individual user.

In another embodiment, the present invention provides a method for authenticating a user including the following steps: providing a first image and at least one subsequent image; morphing the first image into the next of at least one subsequent image; recording at least one graduated image, wherein the at least one graduated image is created during the morphing step such that the at least one graduated image represents a transitional image state between the first image and the next of at least one subsequent image; and utilizing the at least one graduated image to provide a visual representation for identification by the user to authenticate the identity of the user for authorizing access to a secure system. Preferably, the first image and the at least one subsequent image collectively illustrate a related series of images that are solely recognizable by the user, thereby providing a secure authentication of the user. Also preferably, the at least one graduated image provides a unique gradient of morphed images created from a set of images that are identifiable only by a single user for authentication of the identity of that user. The at least one graduated image may represent a transitional image state between the first and next of the series of images, wherein the user may select an image at any time during the process.

Additional steps that may be included with the foregoing include the steps of presenting the at least one graduated image with at least additional image to the user, wherein the additional image is not a correct selection for authenticating the user; and authenticating the user if the user selects the at least one graduated image, thereby providing authorization and/or access to the system for that authenticated user. Also, preferably a step of presenting at least one additional image that is not a correct selection by the user for successfully completing the authentication process is included with the foregoing methods.

In another embodiment of the present invention, the method provides for authenticating a user including the following steps: providing a first image and a second image; morphing the first image to the second image; recording on a computer system or computer readable medium a set of discernable graduated images created during the morphing step; selecting at least one of the discernable graduated images to represent an authentication key; presenting the set of discernable graduated images; and authenticaing the user if the user selects the at least one of the discernable graduate images representing the authentication key.

In the foregoing methods, it is an important factor of the present invention that the images are only recognizable or identifiable by the user, but are otherwise not expressable by the user. By way of example and not limitation, images that are identifiable and recognizable that are effectively usable as the first image and next image are images of a face, and in particular, the face is that of the user making an expression associated with an emotion that is memorable or can be remembered easily by the user, but not otherwise completely or accurately reproduced in any form by the user, including being described or expressed verbally.

Certain modifications and improvements will occur to those skilled in the art upon a reading of the foregoing description. By way of example, in addition to using the methods of the present invention for authenticating a user, they may be used for training a user to select and use a secure authentication key, wherein the system presents visual images to the user including a discernable gradient of morphed images to a user until the user is able to select the correct ones or sequence (if there is a correct sequence). Additionally, the methods of the present invention are preferably made using a computer system having components known in the art, including a visual display for presenting the images to the user and user input means so that the user can input his/her selection to the system for confirming authentication or not, based upon those inputs and corresponding selections. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A method for authentication of an individual comprising:
providing an automated system for controlling access by users, the system including a computer having memory, a processor, a power source, and a display having graphic user interface (GUI), wherein the system is operable for user interaction;
presenting a series of discernable images on the GUI to an individual user; the series of discernable images including a first image and a next image;
requiring the individual user to input at least one selection relating to the series of discernable images;
authenticating the user and authorizing access if the user input matches previously stored initial settings.
wherein the previously stored initial settings are established by the same individual user.

2. The method of claim 1, wherein the first image and next image are images of a face.

3. The method of claim 2, wherein the face is that of the user.

4. The method of claim 2, wherein the images are only recognizable or identifiable by the user.

5. The method of claim 2, wherein the images are only recognizable or identifiable by the user but are otherwise not expressible by the user.

6. The method of claim 2, wherein the images are facial expressions of the user.

7. A method for authenticating a user comprising the following steps:
providing a first image and at least one subsequent image;
morphing the first image into the next of at least one subsequent image;
recording at least one graduated image, wherein the at least one graduated image is created during the morphing step such that the at least one graduated image represents a transitional image state between the first image and the next of at least one subsequent image; and
utilizing the at least one graduated image to provide a visual representation for identification by the user to authenticate the identity of the user for authorizing access to a secure system.

8. The method of claim 7, wherein the first image and next image are images of a face.

9. The method of claim 8, wherein the face is that of the user.

10. The method of claim 7, wherein the images are only recognizable or identifiable by the user.

11. The method of claim 7, wherein the images are only recognizable or identifiable by the user but are otherwise not expressable by the user.

12. The method of claim 7, wherein the first image and the at least one subsequent image collectively illustrate a related series of images that are solely recognizable by the user, thereby providing a secure authentication of the user.

13. The method of claim 7, wherein the at least one graduated image provides a unique gradient of morphed images created from a set of images that are identifiable by a single user for authentication of the identity of that user.

14. The method of claim 7, wherein the user authentication is required for access to a secure system.

15. The method of claim 14, wherein the system is a computer or a computer network.

16. The method of claim 7, wherein the at least one graduated image represents a transitional image state between the first and next of the series of images

17. The method of claim 7, further including the steps of presenting the at least one graduated image with at least additional image to the user, wherein the additional image is not a correct selection for authenticating the user; and
authenticating the user if the user selects the at least one graduated image, thereby providing authorization and/or access to the system for that authenticated user.

18. The method of claim 7, further including the step of presenting at least one additional image that is not a correct selection by the user for successfully completing the authentication process.

19. A method for authenticating a user comprising the following steps:
providing a first image and a second image;
morphing the first image to the second image;
recording on a computer readable medium a set of discernable graduated images created during the morphing step;
selecting at least one of the discernable graduated images to represent an authentication key;
presenting the set of discernable graduated images;
and authenticating the user if the user selects the at least one of the discernable graduate images representing the authentication key.
